(19) United States
(12) Patent Application Publication
(10) Pub. No.: US 2015/0358334 A1
(43) Pub. Date: Dec. 10, 2015

(54) Method for authenticating a client program by a remote data processing system

(71) Applicant: TELEFONAKTIEBOLAGET L M ERICSSON (PUBL), Stockholm (SE)

(72) Inventors: Patrik Lantz, Malmo (SE); Rickard Bellini, Grabo (SE); Ulf Mattsson, Kungsbacka (SE); Bernard Smeets, Dalby (SE)

(21) Appl. No.: 14/762,198

(22) PCT Filed: Jun. 13, 2013
(86) PCT No.: PCT/EP2013/062256

§ 371 Date: Jul. 20, 2015

Related U.S. Application Data
(60) Provisional application No. 61/782,582, filed on Mar. 14, 2013.

(51) Int. Cl. H04L 29/06; G06F 9/445; G06F 21/44

(52) U.S. Cl. CPC H04L 63/12; G06F 21/44; G06F 8/65

(57) ABSTRACT

A method, executed by a data processing device, for verifying authenticity of a client program executed on a processing device, the method comprising: receiving one or more messages from the processing device, and verifying authenticity of the client program based on one or more properties of the received messages; repeatedly updating a first part of the client program, wherein different instances of the first part of the client program cause messages sent by the processing device to have respective detectable properties indicative of the instance of the first part of the client program.

### TECHNICAL FIELD

Disclosed herein are embodiments of methods and corresponding devices for authenticating a client program by a remote data processing system.

### BACKGROUND

Modern processing devices such as user processing devices like laptops, tablets, and smartphones provide users with different tools or services. Today, many of these tools or services use a network to augment capabilities of the tool or service. They may also use the network for other reasons, e.g. because the service is provided by the network and the application on the device mainly functions as a user interface towards this network-based service.

Network-based services may benefit from information that the service can get from the processing device. For example, the Quality of Service (QoS) for a specific service may be increased based on end-user's subscription. The start of the service might be monitored in the device, and relevant information, such as flow (5-tuple) information is sent up to the network nodes in charge of Policy and Charging Control filter enforcement, such as the Policy and Charging Rules Function (PCRF) or the Packet Data Network Gateway (PGW). These nodes may then set filters for specific flows. In a commercial setting the device owner and the service provider do not necessarily completely trust each other in the sense that the user might tamper with or modify the reported information in order to gain some benefit, e.g. increased QoS conditions. It will be appreciated that there are many other situations where it is useful for a client program executed on a processing device to send information to a remote data processing system in a way that allows the data processing system to verify that the information originates from an authentic client program and has not been modified or otherwise tampered with.

Typically, the operator of the data processing system, e.g. a service provider providing a network-based service, does not have complete control over the processing devices it communicates with and, in particular, the software installed on these processing devices, because the user of the processing device may often be able to download and install programs himself. Therefore, there is a need for operators of network-based services or other data processing services to be able to download a trusted client computer program such as an agent, e.g. an app, onto a remote processing device. In particular, it is desirable that the data processing system can trust the thus downloaded client program to collect and return information from the device or otherwise verify the authenticity of messages received from the downloaded client program.

Hence, it is generally desirable to provide protection against user intervention and/or manipulation of data received from a client program executed on a remote processing device. Furthermore the communication should be protected against active wire tappers. Such wire tappers and active wiretapping can occur when the data transport occurs via many physical channels, like the Internet or local connectivity systems, where there are ample opportunities to insert false data or to modify data in transition.

Generally, in client/server architectures it is difficult for the server node to guarantee or verify that it is communicating with a legitimate client. These difficulties are caused by a variety of reasons, including the following:
The client might be hosted at a remote host and there is no control over it to ensure integrity; it might have been tampered with or reversed engineered.
It may be difficult or even impossible for the data processing system to decide whether the reporting data has been spoofed.
Implementing the client as a fixed secure software component in a device is usually not feasible for server operators because this option is normally only available to device manufacturers.

Hence there is a need for a downloadable device agent or other client programs that can be trusted to collect information from a device and that can securely report data with a low risk that the data may be spoofed by outsiders or by a user of the device.

There has been some research on the subject of server-side verification of client behavior. For example, server-side verification has been discussed in the context of verification of client behavior in distributed applications and online games, see e.g. the articles “Toward Online Verification of Client Behavior in Distributed Applications” by R. A Cochran and M. K Reiter, in The 20th Annual Network and Distributed System Security Symposium (NDSS '13), San Diego, Calif., Feb. 24-27, 2013, and “Server-side verification of client behavior in online games” by D. Bethea et al., in Proceedings of the 17th ISOC Network and Distributed System Security Symposium (NDSS '10), February 2010. The approach described in these publications is primarily useful as an online reduction technique to filter out messages that must be analyzed offline. Clients that are not verified immediately could get less privilege while the verification is completed offline.

However, in many situations, user devices may need to be provided with an immediate service or a given QoS may be required immediately. For example, when streaming media, the user of a user device normally expects the QoS he/she is entitled to from the beginning of the streaming session.

It would thus be desirable to provide verification methods that allow for a quick verification of the authenticity of a remote client program. Moreover, it is generally desirable to provide a mechanism that may conveniently be set up and deployed.

### SUMMARY

Based on the above, described herein is a method, executed by a data processing system, for verifying authenticity of a client program executed on a processing device, the method comprising:

receiving one or more messages from the processing device, and verifying authenticity of the client program based on one or more properties of the received messages;

repeatedly updating a first part of the client program, wherein different instances of the first part of the client program cause messages sent by the processing device to have respective detectable properties indicative of the instance of the first part of the client program.

Embodiments of the method disclosed herein thus provide a process allowing a data processing system to verify that a client program executed on a remote processing device is genuine. In particular, the process utilises properties of messages received from the client program, where the properties are determined by a first part of the client program. The first part of the client program is updated repeatedly, thus causing the code implementation of the client program that determines the properties of the messages to change over time. For example, when reporting to a server node, the content and/or format of the messages sent from the client program to the data processing system are generated by the dynamic code implementation of the client program. Hence, the properties of the messages that are used in the verification by the data processing system change over time as well. The verification process may thus be viewed as dynamic puzzles that changes over time.

The verification based on the content and/or format of the received messages may be performed efficiently and quickly, as the level of complexity of each puzzle may be kept relatively low. As the puzzle is changed over time, the risk of an adversary being able to solve one of the puzzles within the time available until the next change of the puzzle is very small. Moreover, the security of the mechanism can be scaled by modifying the complexity of the puzzles and/or by modifying the update frequency. If new dynamic puzzles are sent sufficiently frequently, it will be more difficult to perform reverse engineering, since an adversary is less likely to manage to do so before a completely new puzzle is sent out.

In some embodiments, the client program comprises the first part and a second part, wherein the first part is dynamically loadable into a memory of the processing device during execution of the second part by the processing device. The second part may be a static part. Accordingly, the updating process may comprise repeatedly sending respective updated instances of the first part from an update server to the processing device for dynamic loading of the updated instances and for replacement of respective current instances of the first part during execution of the second part by the processing device. Hence, the updates may be performed dynamically while the client program continues to run, i.e. without the need for stopping and reinstalling the entire client program. Hence, an updating functionality is provided which a client node may use in order to update itself and its main functionality. A main stub of the client code may thus be updated at an arbitrary time interval similar to a plug-in based solution. The data processing system may have or obtain information about which instance, e.g. which dynamic code instance, is currently active and executed on the processing device. Based on that information, the data processing system may verify authenticity of the messages received from the client program. In some embodiments, the client program may encode the message using an encoding mechanism. Different instances of the client program may use different encoding mechanisms. Hence, based on the information about which instance of the client program is currently executed by the processing device, the data processing system is able to decode the received messages. The encoding may include a scrambling process, an obfuscation process, an encryption process, or another suitable process, and/or combinations thereof.

When updating comprises verifying authenticity of each received updated instance of the first part by the second part, the client node may ensure that correct update code is received. Further, when updating comprises verifying authenticity of the second part by the received updated instance of the first part, the updated dynamic code may verify that it is being executed in the correct context and environment. Moreover, when updating comprises verifying authenticity of a currently installed instance of the first part by each received updated instance of the first part, applications are forced to be constantly synchronized with the update process, thus increasing the burden on a potential adversary in order to be able to successfully tamper with the communication between the client and the server.

The various embodiments of the method disclosed herein thus provide a verification of the client behaviour and/or verification that reporting by the client is correct.

The update server which distributes the updated instances and the data processing system that receives the messages from the client program during normal operation of the client program may be the same or different computers or other computational entities, e.g. nodes of a computer network. The data processing system may thus receive information from the update server indicative of which instance of the client program is currently active and/or information on how to decode/interpret messages received from the client program.

In some embodiments, updating comprises receiving an updated instance of the first part from an update server and sending an acknowledgment message, e.g. a message having at least one secret component, to the update server, indicative of successful installation of the updated instance of the first part. In some embodiments, the update server is configured to regard the updated instance of the first part as authentic current instance only, if the update server receives the acknowledgement message within a predetermined period of time. Consequently, an adversary would have to succeed in reverse engineering each instance of the dynamic code within the predetermined period in order to be able to modify or otherwise tamper with messages from the client program while remaining undetected. Once communication between the data processing system and the successfully installed updated instance of the first part has been established, the client program may occupy one specific port now known to the update server.

In some embodiments, verifying authenticity of the client program based on a property of the received message comprises verifying authenticity of the client program based on one or more detectable attributes of a communication protocol used for the communication of messages between the first client program and the data processing system. Consequently, some embodiments of the method disclosed herein exploit the fact that effective communication between two or more nodes requires these nodes to understand each other's messages, i.e. to be able to decode/interpret each other's messages. The communications protocol used for the communication describes the message format and the rules that enable two nodes to understand each other. Consequently, the verification process may be based on an obfuscation of the protocol data, i.e. the communications protocol may be viewed as a puzzle for on outsider. Hence, when seeing the first messages sent using a given communications protocol, an adversary is likely not able to understand the communications protocol and it will take time before the adversary fully grasps the nature of the communications protocol. This fact may be exploited by embodiments of the method described herein so as to allow the data processing system to verify that the data it receives is gathered from a genuine agent and not from an impersonating entity. Examples of suitable obfuscations of the protocol include encrypting or scrambling the messages. For example, if the protocol comprises a plurality of key-value pairs, an obfuscation may comprise a scrambling of the pairs. It is an advantage that an obfuscation of the protocol allows an immediate and fast verification by the receiver and is easy to set up.

Usually, communication is based on a communications protocol represented as a hierarchy of multiple layers. These layers are often represented by layers of the Open Systems Interconnection (OSI) model. In a given communications system, most of these protocol layers cannot be freely modified by a software application due to interoperability requirements. However, application layer protocols can be designed in any way chosen by the application developer as long as all nodes are implemented accordingly. Moreover the specifics of the application layer protocol may be made to change dynamically according to instructions sent by the update server or the data processing system. Consequently, in some embodiments, the attribute of the communications protocol is an attribute of an application layer portion of the communications protocol.

In some embodiments, updating comprises repeatedly sending respective updated instances of the first part from an update server to the processing device; and verifying authenticity of the client program based on a property of the received message comprises sending at least a part of the received message from the data processing system to the update server and receiving information indicative of how to verify and/or decode the received message. Hence, the data processing system may efficiently interpret/decode the received messages.

The communication between the processing device and the data processing system, the communication between the processing device and the update server, and/or the communication between the update server and the data processing system may be performed via any suitable communications link, e.g. a suitable communications network such as wide area network, a local area network, an Internet, a wired or wireless communications network, a cellular telecommunications network, or another suitable communication network, or a combination of the above. In some embodiments the above entities may communicate via the same communications network while, in other embodiments, they may communicate using different communications networks or otherwise different communications channels.

Embodiments of the method disclosed herein may be implemented by a system comprising a processing device executing the client program, a data processing system receiving and verifying messages from the processing device, and by an update server providing repeated updates of at least a first part of the client program to the processing device. Accordingly, the features of embodiments of the methods described herein may be implemented in software and carried out on a processing device, a data processing system, an update server or other processing system caused by the execution of computer-executable instructions. The instructions may be program code means loaded in a memory, such as a Random Access Memory (RAM), from a storage medium or from another computer via a computer network. Alternatively, the described features may be implemented by hardwired circuitry instead of software or in combination with software.

Disclosed herein are different aspects including the method described above and in the following, corresponding further methods, apparatus, devices, systems and/or product means, each yielding one or more of the benefits and advantages described in connection with the first mentioned aspect, and each having one or more embodiments corresponding to the embodiments described in connection with the first mentioned aspect and/or disclosed in the appended claims.

According to one aspect, disclosed herein is a data processing system for verifying authenticity of a client program executed on a processing device, the data processing system comprising:

a communications interface configured to receive one or more messages from the processing device; and

a processing unit configured to:
obtain information indicative of one or more detectable properties of messages from an installed instance of a first part of the client program, wherein different instances of the first part of the client program cause messages sent by the processing device to have respective detectable properties indicative of the instance of the first part of the client program; and
obtain verification of authenticity of the client program based on one or more properties of the received messages.

The information indicative of one or more detectable properties of messages from an installed instance of a first part of the client program may be a version number or other unique identifier identifying the current authentic instance of the client program. Alternatively or additionally, the information may comprise decoding information and/or other suitable information such as implementation characteristics enabling the data processing system to decode or interpret the received messages. In some embodiments, the data processing system obtains the information from the update server. Obtaining verification may comprise requesting authentication from the update server and/or receiving information from the update server facilitating verification by the data processing system.

According to one aspect, disclosed herein is an update server for facilitating verification, by a data processing system, of authenticity of a client program
executed on a processing device, the client program comprising a first part and a second part, the update server comprising a communications interface and a processing unit configured to:

repeatedly send, via the communications interface and responsive to an update schedule, respective updated instances of the first part to the processing device for dynamic loading of the updated instances and replacement of respective current instances of the first part during execution of the second part by the processing device;

send information, via the communications interface, to a data processing system, indicative of one or more detectable properties of messages from an installed instance of a first part of the client program, wherein different instances of the first part of the client program cause messages sent by the processing device to have respective detectable properties indicative of the instance of the first part of the client program. The update server may send the information responsive to a request from a data processing system. The information may e.g. be information about implementation characteristics of the first part such as attributes of an encoding scheme, an obfuscation scheme and/or the like.

The data processing system and/or the update server may be any suitably programmed computer or it may comprise a plurality of computers, e.g. in a distributed processing environment or by one or more virtual machines implemented by a computer network or by one or more dedicated network components, or the like. Hence, in some embodiments, the steps performed by embodiments of the data processing system and/or by the update server may be performed by a computer network in a distributed manner.

According to one aspect, disclosed herein is a processing device comprising a storage medium, a communications interface and a processing unit, wherein the storage medium has stored thereon a client program comprising a first part, and wherein the processing unit is configured to
execute the client program and, under control of the client program, to send one or more messages to a data processing system, each message having one or more respective detectable properties indicative of a instance of the first part of the client program.

The processing device may be any suitable device for performing data processing and communicating with a remote data processing system. The term “processing device” includes but is not limited to user equipment (UE), e.g. a mobile phone, a smart phone, a portable computer, e.g. a tablet computer, or another suitable communications device.

The communications interface may be any suitable device or circuitry for data communication via a wired or wireless communications channel, such as a communication channel using radio-frequency communication, e.g. via a cellular telecommunications system, a wireless local area network, short-range wireless communication slinks such as Bluetooth, etc. or a wired communications channel such as a local area network, a wide area network, an Internet, or the like, and/or combinations thereof. For example, the communications interface may comprise a network adaptor, a network card, a radio-interface, and/or the like.

The processing unit may be any circuitry or device configured to perform data processing, e.g. a suitably programmed microprocessor, a CPU of a computer, of a handheld terminal, or of another processing device or system, a dedicated hardware circuit, etc., or a combination of the above.

The storage medium may be a memory or other suitable storage medium having computer program code stored thereon adapted to cause, when executed by the processing unit, the processing device to perform steps of embodiments of the method described herein.

### BRIEF DESCRIPTION OF THE DRAWINGS

The above and/or additional objects, features and advantages of embodiments of the methods, systems and devices disclosed herein, will be further elucidated by the following illustrative and non-limiting detailed description of embodiments of the methods, systems and devices disclosed herein, with reference to the appended drawings, wherein:

FIG. 1 schematically illustrates parts of an embodiment of a computer system.

FIG. 2 shows a schematic block diagram of an example of the data processing system of FIG. 1.

FIG. 3 shows a schematic block diagram of an example of user processing device.

FIG. 4 shows a schematic block diagram of an example of the update server of FIG. 1.

FIG. 5 shows a schematic view of a verification system, illustrating an example of the message flow between the various entities of the verification system.

FIG. 6 shows a flow diagram of an example of an update process.

FIG. 7 schematically illustrates an example of a mutual verification process.

FIG. 8 shows a flow diagram of an example of a client verification process.

### DETAILED DESCRIPTION

In the following description, reference is made to the accompanying figures, which show by way of illustration how embodiments of the methods, systems and devices disclosed herein may be practiced.

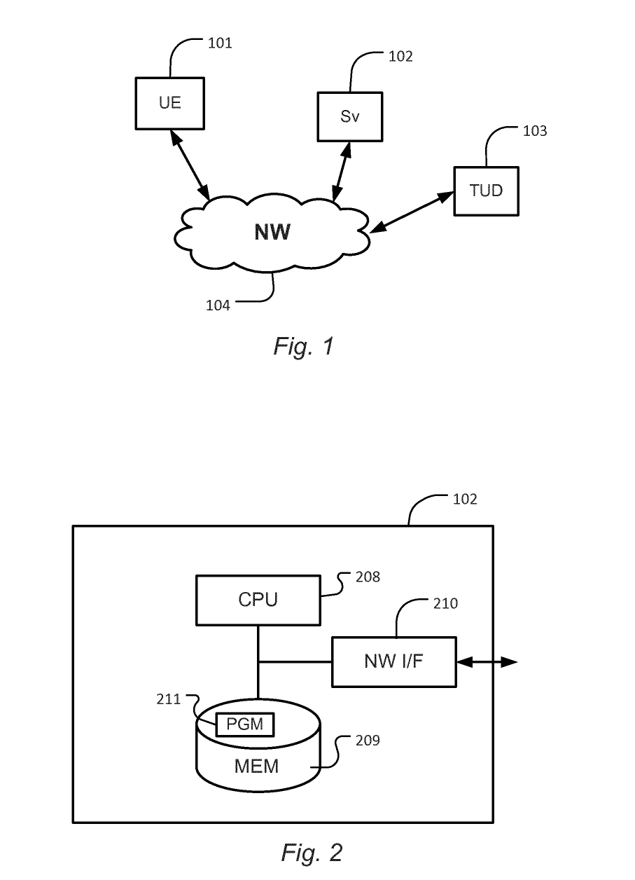

FIG. 1 schematically illustrates parts of an embodiment of a computer system. The system comprises a user processing device 101, e.g. a mobile phone, smart phone, or other suitable User Equipment (UE). The system further comprises a data processing system 102 configured to provide one or more data processing services to the user processing device 101. To this end, the user processing device is adapted to communicate with the data processing system 102 via communications network 104, e.g. comprising a wireless radio-frequency connection. The system further comprises an update server 103. The update server 103 is adapted to communicate with the user processing device 101 via the communications network 104 or via another suitable communications channel. The update server 103 is further adapted to communicate with the data processing system 102, e.g. via the communications network 104 or via another suitable communications channel.

FIG. 2 shows a schematic block diagram of an example of the data processing system 102 of FIG. 1. The data processing system 102 comprises a processing unit 208, a memory 209, and a network interface 210. The memory 209 and the network interface 210 are communicatively connected to the processing unit 208. The processing unit 208 may be a microprocessor, CPU (Central Processing Unit), or other suitable processor. The memory 209 may be any suitable volatile or non-volatile memory or other data storage device. The memory may have computer program code 211 stored thereon adapted to cause the processing unit to perform steps of embodiments of the method described herein that are performed by the data processing device. The network interface 210 may comprise any suitable circuitry adapted to provide a network connection to the user processing device 101 and/or the update server 103.The example of FIG. 2 shows a processor-implemented embodiment, but alternative embodiments could use hardwired elements or a combination of both.

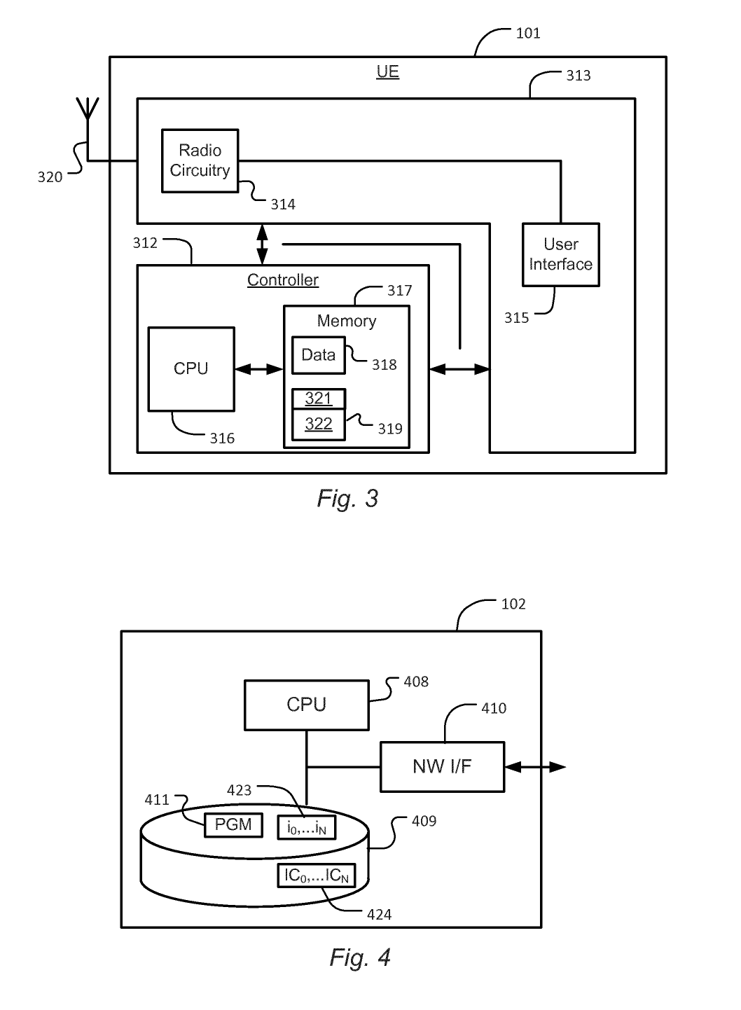

FIG. 3 shows a schematic block diagram of an example of user processing device 101, such as a mobile telephone, a smart phone, a portable computer, or the like. The user processing device 101 comprises a controller 312 and other circuitry and/or hardware components 313 suitably connected to the controller 312. The controller 312 comprises a processing unit 316 and a memory 317 connected to the processing unit. The processing unit 316 may be a microprocessor, CPU, or other suitable processor. The memory 317 may be any suitable volatile or non-volatile memory or other data storage device. The memory 317 has stored thereon data 318 and computer program code implementing a client program 319, the client program 319 being adapted to cause the processing unit 316 to perform processes to be performed by the user processing device, such as the steps of embodiments of the method described herein that are performed by the processing device. In particular, the client program 319 comprises a static part 321 and a dynamically loadable part 322, as described herein. The dynamically loadable part implements an application layer protocol for communicating with a server data processing system. The other hardware components/circuitry 313 may comprise a user interface 315, e.g. a display, keyboard, keypad, touch screen, and/or the like. The user processing device 101 further comprises radio circuitry 314 for radio communication via an antenna 320 with a radio-based communications network, e.g. the communications network 104 of FIG. 1. The example of FIG. 3 shows a processor-implemented embodiment, but alternative embodiments could use hardwired elements or a combination of both.

FIG. 4 shows a schematic block diagram of an example of the update server 103 of FIG. 1. The data processing system 103 comprises a processing unit 408, a memory 409, and a network interface 410. The memory 409 and the network interface 410 are communicatively connected to the processing unit 408. The processing unit 408 may be a microprocessor, CPU (Central Processing Unit), or other suitable processor. The memory 409 may be any suitable volatile or non-volatile memory or other data storage device. The memory may have computer program code 411 stored thereon adapted to cause the processing unit to perform steps of embodiments of the method described herein that are performed by the update server. The network interface 410 may comprise any suitable circuitry adapted to provide a network connection to the user processing device 101 and/or the data processing system 102. The example of FIG. 4 shows a processor-implemented embodiment, but alternative embodiments could use hardwired elements or a combination of both.

The update server 103, also denoted as Trusted Update Distributor (TUD), keeps several distinct instances of dynamic code 423, e.g. stored in memory 409. The update server may reside in the network 104 in the operator's domain, e.g. as a standalone node/server or as part of another network node such as a Policy and Charging Rules Function (PCRF) or a Packet Data Network Gateway (PGW). When the update server is within the network operator's domain, an adversary is prevented from setting up a shadow update server that has the authority to communicate with nodes that are in charge of the Policy Control and Charging (PCC) filter enforcement within the operator's network. The instances of dynamic code are distinct in that each instance generates reporting data in a different unique way that is not known beforehand. The dynamic code might also be dynamically generated on-the-fly.

The update server also has the ability to be polled for information in order for some node, e.g. the server data processing system 102, to verify if it is communicating with an active update code instance. For each update code instance, the update server also stores information 424 about the Implementation Characteristics (IC). The implementation characteristics describe how to uniquely identify reporting data for a specific instance and how to decode/interpret it.

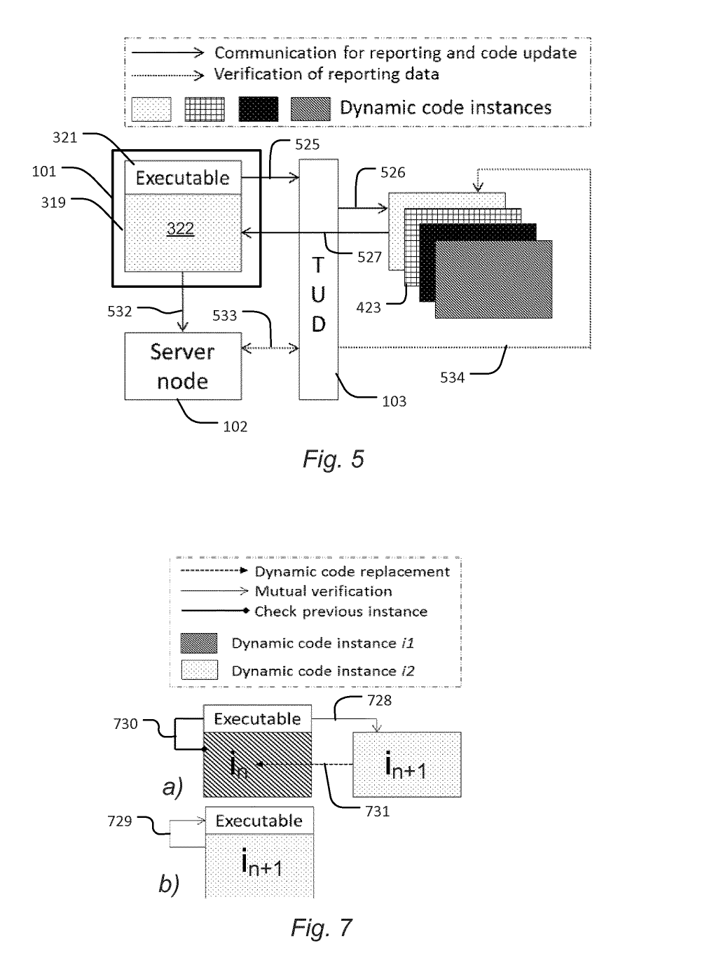

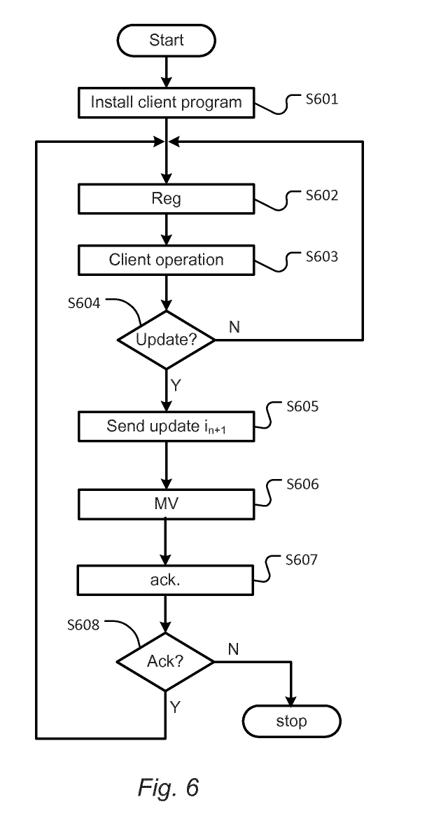

FIG. 5 shows a schematic view of a verification system, illustrating an example of the message flow between the various entities of the verification system. The system comprises a client program 319, comprising a static part 321 and a dynamically loadable part 322. The client program is executed on a user processing device 101, as described above. The system further comprises a server data processing system 102 and an update server 103 maintaining multiple instances of dynamic code 423, all as described above. An example of the code update and verification process will now be described with reference to FIGS. 6-8, and with continued reference to FIG. 5.

FIG. 6 shows a flow diagram of an example of an update process. Initially, in step S601, a client program is installed in the user processing device. For example, the user may cause the client program to be downloaded and installed onto the user processing device. In order to provide its full functionality, the client program requires a dynamically loadable program code i. For the purpose of the present description, the term dynamic loading of program code is intended to refer to a mechanism a mechanism by which a program can, at run time, load a library (or other executable program code) into memory such that the functions provided by the library may be executed. The dynamic loading may thus comprises one or more of retrieving of the addresses of functions and variables contained in the library, executing those functions or access those variables, and unloading the library from memory. Upon initial installation, the client program may comprise an initial instance i₀ of the dynamically loadable code; alternatively, the client program may initially be installed without any instance of the dynamically loadable code, i.e. initially only a static part may be installed. By exploiting dynamic code loading the user processing device can update parts of the client program remotely and dynamically without having to replace or restart the entire application.

During initial execution of the client program, in step S602, the client program initiates a registration procedure with an update server 103, e.g. by sending a corresponding registration request 525. Upon successful registration, the client program receives, from the update server, a currently valid instance iₙ of the dynamically loadable code. Similarly, each time the client program sets up a connection or a Packet Data Protocol (PDP) context, an initial instance is sent to the user processing device. After that, the update server is in charge of determining when to send out a new instance as described below.

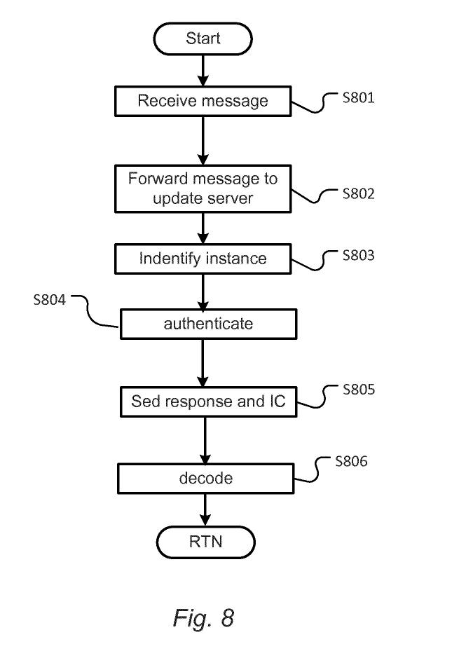

In step S603, the client program takes up normal operation providing its services the user of the user processing device. In particular, as part of the normal operation, the client program sends messages to a server data processing system 102, where the content and/or format of the messages are determined by the currently installed instance iₙ of the dynamically loadable code, as will be described in greater detail below and with reference to FIG. 8.

In step S604, the update server executes a scheduling algorithm so as to determine which instance of the dynamically loadable code is the currently valid instance, as illustrated by arrow 526 in FIG. 5. The scheduling algorithm may be specific for the user device or a group of user devices, e.g. all user devices within a certain geographical area, all user-devices executing a certain operating system, or all user-devices having another property in common. In yet another embodiment, all user devices may be updated using the same update schedule. In any event, the update server maintains a record of what instance of the dynamically loadable code is currently active for the client program. Generally, the scheduling algorithm may, for example, update the dynamically loadable portions at regular time intervals, triggered by certain events, and/or at random time intervals, or a combination thereof.

When the update server determines that it is time to push out an updated instance iₙ₊₁ to at least the user processing device 101, the process proceeds at step S605; otherwise the process returns to S603 allowing the client program to continue normal operation.

In step S605, the update server sends an updated instance iₙ₊₁ of the dynamic code to the user processing device and, optionally, to some or all other processing devices having installed the client program, as illustrated by arrow 527 in FIG. 5. The dynamic code instances may be selected from a sequence of pre-generated instances stored by the update server, or they may be generated on-the-fly or periodically, for example once a day. Hence, an adversary is forced to be constantly aligned with the updating process, rendering misuse difficult to achieve, in particular when there are no reoccurring instances of dynamic code in the sequence.

In step S606, upon receipt of the updated instance of the dynamically loadable code, the client program and the updated instance perform a mutual verification (MV). It will be appreciated that the client program and the update server may authenticate each other; however, the authentication process might get compromised in various ways. Therefore, embodiments of the process described herein comprise control checks implemented both in the static part of the client program and in the dynamic code. For the purpose of the present description, these control checks will also be referred to as mutual verification.

More specifically, FIG. 7 schematically illustrates an example of a mutual verification process. FIG. 7a schematically illustrates an update of the dynamic code part of a client program from a currently installed instance iₙ to an updated instance iₙ₊₁. FIG. 7b illustrates the client program after installation of the updated instance.

In particular, in the present embodiment, the mutual verification process comprises the following checks:

(a) The client program verifies (728) that it has received a valid instance of the dynamic code.

(b) The updated instance iₙ₊₁ checks(729) whether it has been loaded and executed in a valid client program context.

(c) The updated instance iₙ₊₁ verifies(730) that the actual instance that is being replaced is the authentic previous instance iₙ.

The verification step (a) may be based on a digital signature. For example, the update server may digitally sign the updated instance of the dynamic code by a private key available to the client program, e.g. the same private key with which the client program has been signed. For example, some operating systems, such as the Android operating system, provide functionality for authenticity verification of a received complete application using digital signatures. Embodiments of the method described herein may implement a verification mechanism that verifies a received dynamic part of an application. When the client program receives an update of the dynamic code, it can verify that the update has been signed with the same key as itself before loading the updated code into memory.

Once loaded (731), the updated instance iₙ₊₁, may perform the check (b), e.g. by implementing Dynamic Verification Methods (DVM). One DVM solution is to check different unique context-specific attributes of the client program. Additionally or alternatively, the new instance may scan its environment using suitable Operating System (OS) commands, and send the retrieved results back to the update server. Examples of attributes that may be checked by the updated instance of the dynamic code include the name of the process of the client program or an attribute of the environment of the system. Only if the check (b) is completed successfully, the updated instance allows itself to execute properly.

In addition to the verification of the client program, i.e. the static parent or host portion of the client program, the updated instance of the dynamic code may also perform the check (c) before it allows itself to execute properly; this forces applications to be constantly synchronized with the update process. This may be part of a DVM where the new dynamic code instance verifies that the application's previous instance was indeed valid. For example, each successfully loaded instance may store a check value (e.g. a secret key) in the memory of the device. The updated version may thus verify that the correct check value is presently stored in the memory of the device. Only if this is the case, the updated instance of the dynamic code overwrites the previous check value with its own check value, and starts normal operation. If any of the above checks fail, the update process is aborted, thus causing subsequent communication from the client program to the server data processing system to fail authentication.

Again referring to FIG. 6 and with continued reference to FIG. 5, in step S607, and subject to successful completion of the check process of step S606, the updated instance of the dynamic code sends a send a secret acknowledgement message back to the update server.

In step S608, the update server verifies whether it receives a valid acknowledgement message within a predetermined period of time. If not, the update server marks the client program as unauthentic and informs the server data processing system accordingly. In some embodiments, the process may allow for a certain number of new attempts to be made to complete a successful update before marking the client program as unauthentic.

For example, in order to prevent a malicious client from learning all new dynamic puzzles, the update server may implement a throttling mechanism that restricts the number of retries to a predetermined number. Also, the end-user is typically known by the operator by means of the Mobile Station International Subscriber Directory Number (MSISDN) or another subscription identifier. Consequently, if the update server or the server data processing system detects suspicious behaviour, the operator may initiate sample testing of used traffic in the network, e.g. by Deep Packet Inspection, and eventually cancel or suspend the subscription of the end-user. Additionally or alternatively, upon installation of a new instance, the new instance may scan its environment using suitable Operating System (OS) commands, and send the retrieved results back to the update server. In this way, the update server may detect the presence of a suspicious client program in the user processing device. Moreover, in some embodiments, the dynamic code instances are generated such that they all have respective hash values, i.e. that no two instances have the same hash value, thereby preventing an adversary from monitoring dynamic code instances so as to recognise a previously received instance.

Upon successful update, the process returns to step S603 and the client program continues normal operation. The client program including the updated dynamic code now occupies one specific port (now known to the update server) on the Internet Protocol (IP) address. In particular, if the update server and the server data processing system are implemented as a single computer, the knowledge of the port may be used for subsequent authentication.

FIG. 8 shows a flow diagram of an example of the client verification process. As mentioned above, the client program sends messages (indicated by arrow 532 in FIG. 5) to the server data processing system whose content and/or form depend on the currently installed instance of the dynamic code. A server data processing system 102 communicating with a client program may perform the following verification process so as to verify that the received message originates from a legitimate client program, i.e. from a client program having loaded a valid instance of the dynamic code that is used to generate the message, and from a dynamic code executed in the context of a verified application (e.g. verified by the mutual verification process described above).

In step S801, the server data processing system receives a message 532 from the client program.

In step S802, the server data processing system forwards the received message to the update server as indicated by arrow 533 in FIG. 5.

In step S803, the update server identifies which instance of the dynamic code is currently running as indicated by arrow 534 in FIG. 5. For example, to this end, the message may include a unique identifier identifying the client program and/or other information such as an identification of the data processing system, a geographic location, and/or the like. Alternatively, if the dynamic code is common to a plurality of different client programs (for example, the dynamic code may implement an application layer protocol for client-server communication that may be used for different client programs), the update server may not need any information in order to be able to identify the current instance of the dynamic code.

In step S804, the update server compares the message with the implementation characteristics of the currently active instance of the dynamic code so as to determine whether the received message is authentic. The update server further retrieves instructions for how to decode/interpret the message, e.g. a decryption key and/or other attributes identifying an obfuscation algorithm.

In step S805, the update server sends a response (533) to the data processing system indicative of whether the message is from an authentic client program. If the message is authentic, the update server further returns instructions as to how to decode/interpret the message.

In step S806, the data processing system decodes/interprets the contents of the message based on the received instructions.

It will be appreciated that the authentication step S804 and the decoding step S806 may be performed by the update server or the server data processing system. The suitable choice as to which entity performs these steps may depend on the communications bandwidths between them and the computational resources available at each entity.

In most communications systems, only a single application can use a specific port. Hence, if correct authentication of the client program including the dynamic code has been done once and a port has been assigned to the communication between the client program and the server data processing system, the port can be used as an identifier to secure that communication is not tampered with.

Although some embodiments have been described and shown in detail, the aspects disclosed herein are not restricted to them, but may also be embodied in other ways within the scope of the subject matter defined in the following claims. In particular, it is to be understood that other embodiments may be utilized and structural and functional modifications may be made.

In device claims enumerating several means, several of these means can be embodied by one and the same item of hardware. The mere fact that certain measures are recited in mutually different dependent claims or described in different embodiments does not indicate that a combination of these measures cannot be used to advantage.

It should be emphasized that the term “comprises/comprising” when used in this specification is taken to specify the presence of stated features, integers, steps or components but does not preclude the presence or addition of one or more other features, integers, steps, components or groups thereof.

1. A method, executed by a data processing system, for verifying authenticity of a client program executed on a processing device, the method comprising:
receiving one or more messages from the processing device, and verifying authenticity of the client program based on one or more properties of the received messages;
repeatedly updating a first part of the client program, wherein different instances of the first part of the client program cause messages sent by the processing device to have respective detectable properties indicative of the instance of the first part of the client program.

2. A method according to claim 1, wherein the client program comprises the first part and a second part, wherein the first part is dynamically loadable into a memory of the processing device during execution of the second part by the processing device.

3. A method according to claim 2, wherein updating comprises repeatedly sending respective updated instances of the first part from an update server to the processing device for dynamic loading of the updated instances and for replacement of respective current instances of the first part during execution of the second part by the processing device.

4. A method according to claim 2, wherein updating comprises verifying authenticity of each received updated instance of the first part by the second part.

5. A method according to claim 2, wherein updating comprises verifying authenticity of the second part by the received updated instance of the first part.

6. A method according to claim 2, wherein updating comprises verifying authenticity of a currently installed instance of the first part by each received updated instance of the first part.

7. A method according to claim 1, wherein updating comprises receiving an updated instance of the first part from an update server; sending an acknowledgement message to the update server indicative of successful installation of the updated instance of the first part; and determining the updated instance of the first part as successfully installed current instance only, if the update server receives the acknowledgement message within a predetermined period of time.

8. A method according to claim 1, wherein verifying authenticity of the client program based on a property of the received message comprises verifying authenticity of the client program based on one or more detectable attributes of a communications protocol used for the communication of messages between the first client program and the data processing system.

9. A method according to claim 8, wherein the attribute of the communications protocol is an attribute of an application layer portion of the communications protocol.

10. A method according to claim 8, wherein updating comprises repeatedly sending respective updated instances of the first part from an update server to the processing device; and wherein verifying authenticity of the client program based on a property of the received message comprises sending at least a part of the received message from the data processing system to the update server and receiving information indicative of how to verify and/or decode the received message.

11. A data processing system for verifying authenticity of a client program executed on a processing device, the data processing system comprising:
a communications interface configured to receive one or more messages from the processing device; and
a processing unit configured to
obtain information indicative of one or more detectable properties of messages from an installed instance of a first part of the client program, wherein different instances of the first part of the client program cause messages sent by the processing device to have respective detectable properties indicative of the instance of the first part of the client program; and
obtain verification of authenticity of the client program based on one or more properties of the received messages.

12. An update server for facilitating verification, by a data processing system, of authenticity of a client program executed on a processing device, the client program comprising a first part and a second part, the update server comprising a communications interface and a processing unit configured to:
repeatedly send, via the communications interface and responsive to an update schedule, respective updated instances of the first part to the processing device for dynamic loading of the updated instances and replacement of respective current instances of the first part during execution of the second part by the processing device;
send information, via the communications interface to the data processing system, indicative of one or more detectable properties of messages from an installed instance of the first part of the client program, wherein different instances of the first part of the client program cause messages sent by the processing device to have respective detectable properties indicative of the instance of the first part of the client program.

13. A processing device comprising a storage medium, a communications interface and a processing unit, wherein the storage medium has stored thereon a client program comprising a first part, and wherein the processing unit is configured to
execute the client program and, under control of the client program, to send one or more messages to a data processing system, each message having one or more respective detectable properties indicative of an instance of the first part of the client program.
repeatedly receive and execute respective updated instances of the first part from an update server.

14. A nontransitory computer-readable storage medium comprising computer-readable program code configured to cause a data processing system, when executed by the data processing system, to:
receive one or more messages from a processing device;
obtain information indicative of one or more detectable properties of messages from an installed instance of a first part of a client program executed on the processing device, wherein different instances of the first part of the client program cause messages sent by the processing device to have respective detectable properties indicative of the instance of the first part of the client program; and
obtain verification of authenticity of the client program based on one or more properties of the received messages.

15. A nontransitory computer-readable storage medium comprising computer-readable program code configured to cause an update server, when executed by the update server, to:
repeatedly send respective updated instances of a first part of a client program executed by a processing device to the processing device for dynamic loading of the updated instances and replacement of respective current instances of the first part during execution of a second part of the client program by the processing device;
send information indicative of one or more detectable properties of messages from an installed instance of the first part of the client program, wherein different instances of the first part of the client program cause messages sent by the processing device to have respective detectable properties indicative of the instance of the first part of the client program.

16. A nontransitory computer-readable storage medium comprising computer-readable program code configured to cause a processing device, when executed by the processing device, to:
execute the client program and, under control of the client program, to send one or more messages to a data processing system, each message having one or more respective detectable properties indicative of an instance of a first part of the client program;
repeatedly receive and execute respective updated instances of a first part of the client program from an update server.
